(19) United States
(12) Patent Application Publication
(10) Pub. No.: US 2012/0248868 A1
(43) Pub. Date: Oct. 4, 2012

(54) SWAPPABLE BATTERY CAR AND BATTERY CAR STATION

(76) Inventors: Fahim Usshihab Mobin, Orefield, PA (US); Irfan Ahmad Mobin, Orefield, PA (US); Ian Michael Hughes, Malvern, PA (US); Dil Afroz Mobin, Orefield, PA (US)

(21) Appl. No.: 13/438,217

(22) Filed: Apr. 3, 2012

Related U.S. Application Data
(60) Provisional application No. 61/471,386, filed on Apr. 4, 2011.

(51) Int. Cl. B60L 1/00; B66C 25/00

(52) U.S. Cl. 307/9.1; 414/589

(57) ABSTRACT

In described embodiments, a battery car employed in conjunction with a battery car station employs a swappable battery configuration. Batteries are of differing types depending on provision of high current or high voltage, with each having a energy sensor. Access to the batteries of differing types is controlled through a switch control processor selectively coupling batteries to one or more power grids depending upon a given battery's sensed energy. Access to the batteries of differing types is based on demands of vehicle operation. Based on such configuration, a swappable battery car station in communication with the battery car might then selectively replace batteries as needed.

### CROSS-REFERENCE TO RELATED APPLICATIONS

This application claims the benefit of the filing date of U.S. provisional application No. 61/471,386, filed on 04-APR-2011 as attorney docket no. 31.5.002Prov, the teachings of which are incorporated herein by reference.

### BACKGROUND OF THE INVENTION

1. Field of the Invention

The present invention relates to hybrid or electric vehicle systems and, more particularly, to a swappable battery car and a battery car service station.

2. Background of the Invention

in transportation systems, the operator employs a transporter that can use one or more of various types of fuel systems for an engine to provide power. Most common fuel systems include gasoline, renewable and nonrenewable gases, electric energy, or a combination thereof to provide power by the engine. Recent trends towards electricity-based powered transportation in the form of an electric or hybrid electric vehicle uses electric motors or a combination of electric motors and gas/gasoline motors to provide power to the wheels. Vehicles incorporating electric power typically include one or more batteries to store energy, and usually generate electricity to charge these batteries when energy is either not needed or would have been wasted if not utilized. Fully battery-operated vehicles charge batteries via a static or otherwise fixed location electric outlet, and/or charge their batteries via a generator. The generator might typically be powered from the wheels via the drive-train during downhill movement or coasting of the vehicle (in fully electric vehicles) or powered by the alternate source such as the gas/gasoline engine in the case of the hybrid vehicle.

### SUMMARY OF THE INVENTION

This summary is provided to introduce a selection of concepts in a simplified form that are further described below in the detailed description with reference to the drawings. This summary is not intended to identify key features or essential features of the claimed subject matter, nor is it intended to limit the scope of the claimed subject matter.

In one embodiment, the present invention allows for powering a transporter having an electric motor powering a drive-train. A battery chamber retains a plurality of battery modules, the plurality of battery modules including at least two battery types and wherein each battery module comprises a power level sensor and indicator. The transporter includes at least one power grid, with one power grid coupled to and providing power to the electric motor; and a switch array coupled between the motor power grid and the plurality of battery modules. A switch control processor, coupled to the switch array and to each of the plurality of battery modules, receives i) corresponding energy level from each battery power level sensor and indicator, ii) a battery type identity, and iii) operational mode corresponding to the transporter. The switch control processor selectively enables and disables switches of the switch array so as to selectively activate one or more batteries in a unidirectional, isolated connection manner so as to power the motor via the motor power grid. The switch control processor selectively activates the one or more battery modules based on the corresponding energy level from each battery power level sensor and indicator and the battery type identity for each battery so as to concurrently provide the power for the operational mode of the transporter while reducing a number of battery modules providing the power.

In another embodiment, the present invention allows for a battery service station comprising a scanning device and a crane. The scanning device identifies a set of battery modules of the plurality of battery modules and types in said battery chamber for replacement or for charging, based on each corresponding power level sensor and indicator of the plurality of battery modules indicating a decommissioned battery in said battery chamber. The crane i) unlocks and removes a decommissioned battery from said battery chamber; ii) inserts and locks a new battery in said battery chamber; and ii) charges a battery module in said battery chamber. The scanning device identifies each given type of battery module, and the battery service station, based on an indication of a decommissioned battery, either i) replaces the decommissioned battery with a charged battery above the second energy level of the given type or ii) charges the decommissioned battery in the battery chamber.

### BRIEF DESCRIPTION OF THE DRAWINGS

Other aspects, features, and advantages of embodiments of the present invention will become more fully apparent from the following detailed description, the appended claims, and the accompanying drawings in which like reference numerals identify similar or identical elements.

FIG. 1 shows an exemplary battery charging facility exchanging a used battery with a charged battery in accordance with an embodiment of the present invention;

FIG. 2 shows the battery compartment of an exemplary battery car comprising a number of battery types as employed with the battery charging facility of FIG. 1;

FIG. 3 shows a switch control processor controlling a battery connection configuration of the exemplary battery car of FIG. 2;

FIG. 4 shows an exemplary method of providing input to the switch control processor of FIG. 3 by the operator of the battery car;

FIG. 5 shows an exemplary network of Type A and a network of Type B batteries under control of the switch control processor of FIG. 3;

FIG. 6 shows operation of the switch control processor to control switches for grid activation as a recharged battery with Ehi energy dissipates to Elo energy;

FIG. 7 illustrates exemplary functional operation of the switch control processor along with battery status indication;

FIG. 8 shows various options of battery status indication to a vehicle operator of an exemplary battery car;

FIG. 9 illustrates an exemplary operation of the battery switching station of FIG. 1 sensing and replacing batteries automatically or by manual entry;

FIG. 10 shows an exemplary mechanism coupling a battery to a motor power grid when the battery energy level is above a first energy threshold and connecting the battery to an alternative device grid when the battery energy level is between the first energy threshold and a second energy threshold; and

FIG. 11 illustrates isolation of batteries for recharging on a grid from batteries requiring swapping at a battery car station.

### DETAILED DESCRIPTION

In accordance with exemplary embodiments of the present invention, a transporter having electric power, such as an electric or hybrid-electric vehicle, employs a set of batteries. The set of batteries includes different types of batteries, one type suitable for quick and high current delivery, one type suitable for sustained constant current, one type suitable for constant current at high voltage, and one or more other types providing a combination of varying current and voltage ranges. Each battery of the set might be used by the transporter independently from each other battery of the set via a switch and switch control processor. The switch control processor utilizes one or more batteries of the set in various connection configurations to meet current and voltage demands set by the operation of the vehicle. When selected ones of the set of batteries are fully or partially exhausted, the switch control processor switches these selected ones off of the power grid of the transporter and switches in new batteries on to the grid.

A vehicle might be equipped with slots to physically retain the set of batteries. Fully discharged batteries might then be physically removed from the vehicle (or otherwise permanently removed from the power grid when their energy level falls below a preset energy threshold), and the vehicle slot(s) replaced with new batteries in a local (e.g., home) or remote battery switching station. Partially charged batteries stays in the grid until they lose their energy below a preset energy level. Voltage regulation is employed to isolate each battery within the power grid to prevent fully charged batteries from loading effects (reverse charge) by partially exhausted batteries.

Embodiments of the present invention might provide the following advantages. A gasoline or gas operated vehicle my refuel at an appropriate gasoline or gas refueling station. The time required for an operator to refuel a gas or gasoline vehicle is typically relatively short. In contrast, electric or hybrid electric vehicles require considerable time to re-charge batteries, which might cause issues when attempting to employ the electric or hybrid electric vehicle on a trip covering a long distance. In addition, electric or hybrid electric vehicles employ several specialized types of batteries to allow for, for example, storing considerable charge, providing for short bursts of high power, and for rapid charge. A transporter employing one or more embodiments of the present invention might allow for a battery station to identify certain types of batteries that are discharged in the transporter and physically replace those batteries with fully charged batteries, allowing for a relatively quick recharging of the electric or hybrid electric vehicle. Such batteries might be relatively inexpensive when compared to other, more specialized types of batteries employed in the transporter.

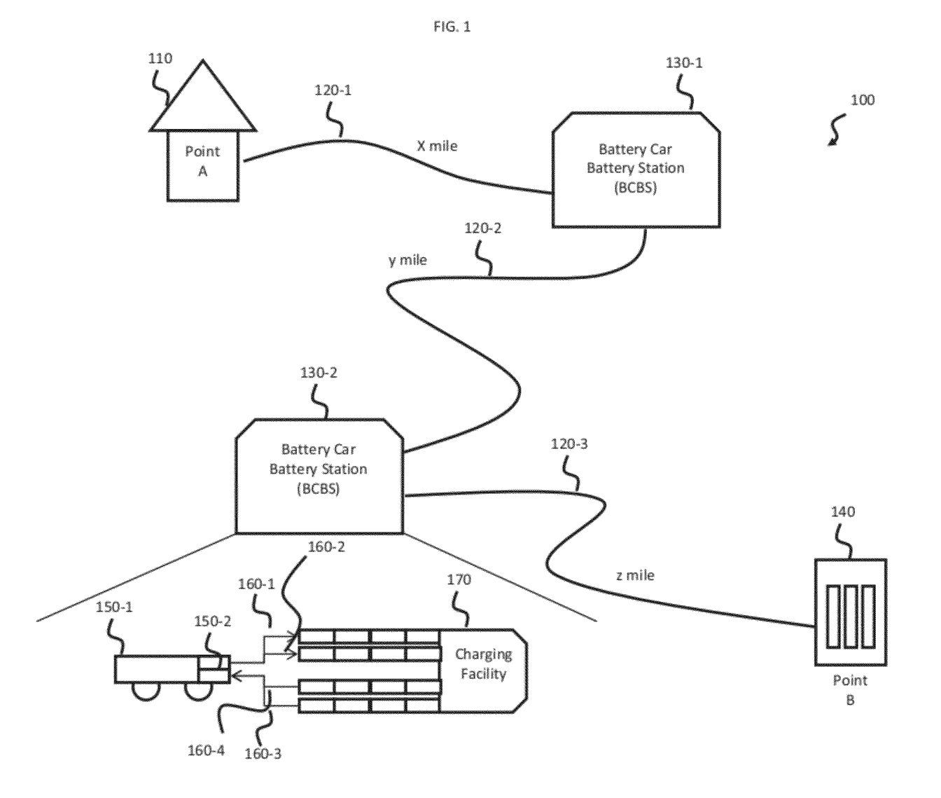

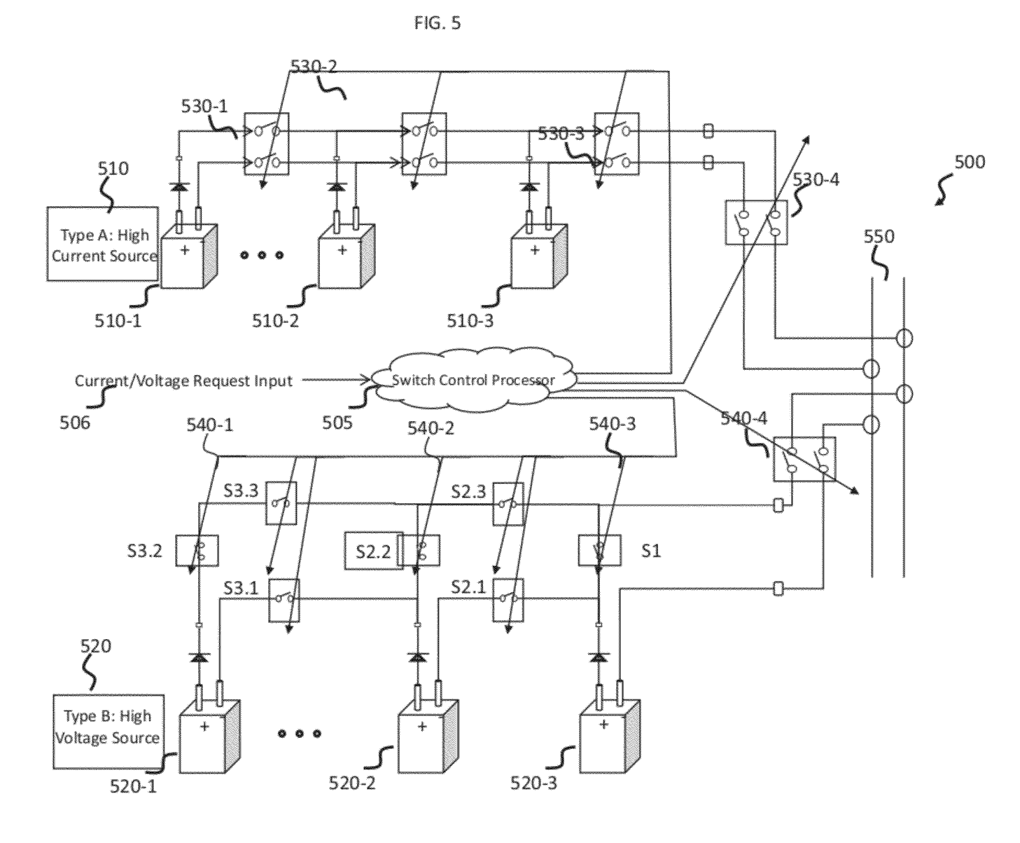

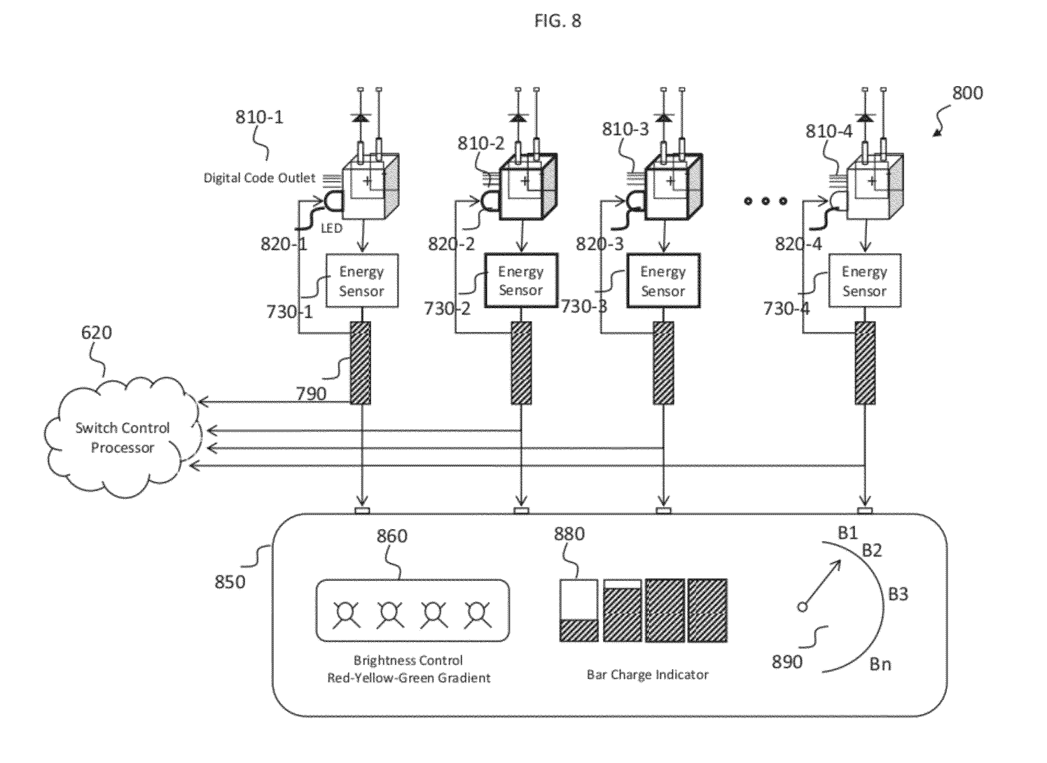

FIG. 1 shows exemplary operation of battery station 100 in accordance with an exemplary embodiment of the present invention. As employed herein, the term “battery car” encompasses electric or hybrid electric based vehicles that employed chargeable electric storage devices to power or assist in powering the vehicle. Battery car 150-1 from starting point 110 travels a length of distance 120-1 to battery station 130-1. Battery car 150-1 swaps partially used up batteries at battery station 130-1 and travels another length of distance 120-2 before replacing another set of used batteries at battery station 130-2. Battery car 150-1 then continues another length of distance 120-3 before reaching destination 140. The battery compartment 150-2 of the battery car 150-1 contains a set of batteries of different kinds as described in detail subsequently with respect to FIG. 5. Battery station 100 detects battery type and battery energy level for the set of batteries as described in detail with respect to FIG. 8. Battery station 100 removes only the discharged batteries and routes them to charging queues 160-1 and 160-2 of charging facility 170 based on their battery type. Charged batteries from charging facility 170 are routed via a delivery queue 160-3 and 160-4 based on their battery type and delivered to the emptied battery slot in battery compartment 150-2.

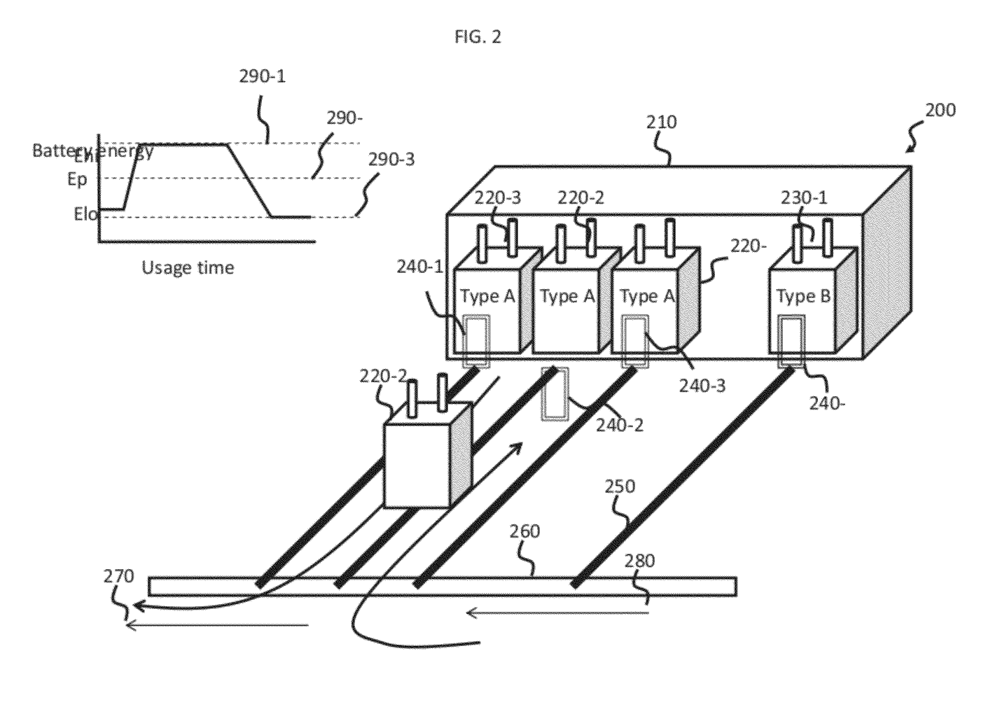

FIG. 2 shows the battery compartment 150-2 of FIG. 1 having battery compartment cover 210, and a set of batteries including various battery types, shown in the figure as batteries 220-1 to 220-3 of battery type A and battery 230-1 of battery type B. Each battery is locked in the battery chamber with battery latches 240-1 to 240-4 so as to be unlocked by pushing lever 250 connected to the latch when battery needs to be removed or inserted in the battery compartment without restricting other means of locking a battery in the battery compartment. As discussed above, the set of batteries includes individual smaller battery units of various types, type A, type B and so on such that, tbr example, a battery of type A is capable of generating very high current required at startup of acceleration time, a battery of type B is capable of generating steady current required for speed maintenance. At a given time not all batteries are employed or coupled to a power grid concurrently. Individual batteries are selectively used in small groups until their charges are exhausted below a certain threshold. After a lowest threshold is reached, Elo 290-3, the given battery is retired from the main power grid that drives the motor driving the wheels, referred to herein as decommissioning of the battery. If a total energy of a current battery group in service is not exhausted but instead falls below a lower threshold, Ep 290-2, then another group of new batteries with charges greater than Ehi 290-1 is switched in, utilizing this new group as the main power source for the motor, and the previous battery group might be switched so as to offer additional residual current to the power grid to maximize their utilization and that of the new group.

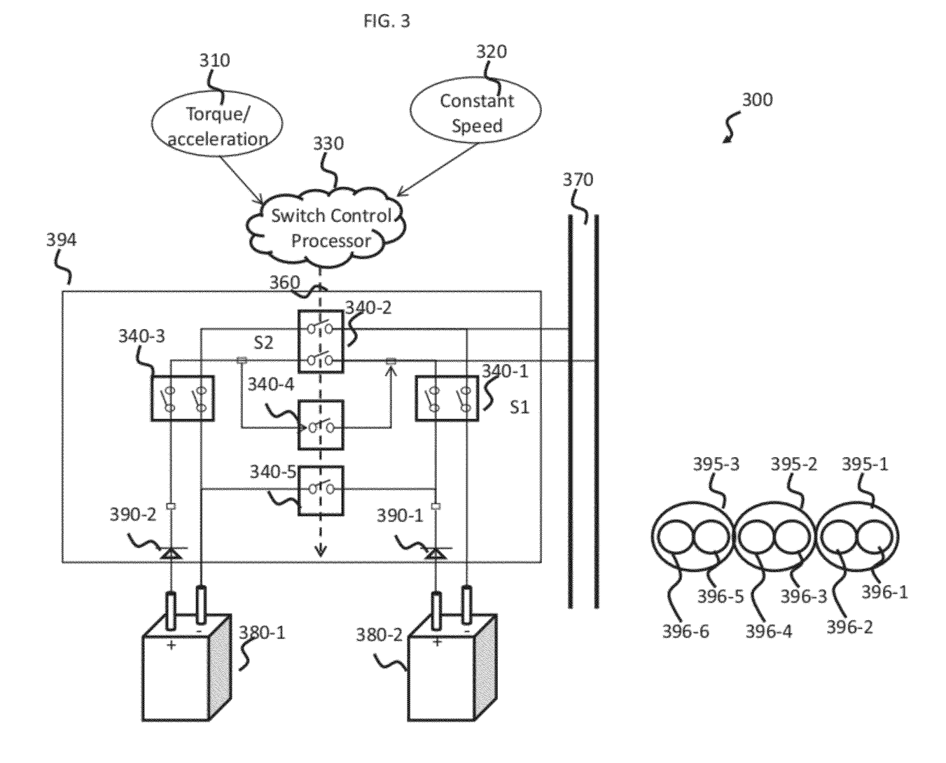

In another embodiment, the current battery group is supplemented by additional batteries to supply energy to motor power grid when demanded by the operator of the vehicle in additional current-voltage form. The reverse charging of the batteries with low energy by batteries with high energy is blocked by power diodes 390 shown in FIG. 3. At a given time the battery compartment may contain batteries with various states of energy. Some battery with energy equal to or above 290-1, some batteries with energy less than or equal to 290-3, and battery energy in between 290-1 and 290-3, in a battery fueling station or battery swapping station individual batteries with energy level below Elo may be swapped or charged, batteries with energy level below Ep but higher than Elo may be swapped or charged, batteries with energy level below Ehi but larger than Ep may be swapped or charged.

For some embodiments, in the case of swapping, a fixed billing amount might be set based on the battery type to be swapped or by the estimated amount of energy required to fully replenish the battery. In the case of charging, the billing is based on the energy consumed by the battery. When a battery is swapped, lever 250 from battery charging station pushes the battery lock latch to unlock the battery (or by other appropriate means to unlock the battery known in the art), and then remove the battery from the battery compartment via, for example, as robotic arm, hydraulic lift, block/pulley, and the like. The battery is drawn out of the battery compartment and placed on conveyer belt 260 in the battery station. A discharged battery is routed in the direction of charging queue 270. A charged battery from the battery station (typically, with same or interchangeable type) is delivered to the battery compartment from charged battery delivery queue 280. After the swapping operation is complete, the battery lock is latched to lock the battery in the battery compartment.

Battery modules and use thereof in the battery compartment are utilized and controlled by a battery car switch control processor. The battery car switch control processor is a dedicated processing unit with, for example, a microprocessor, memory and various input/output interfaces. Such battery car switch control processor provides computing and algorithm execution, as well as control of other types of sub-system modules (such as WiFi module). Such computing and algorithm execution might provide for receiving and processing sensor information, translation of such sensor information into control signals, and control of various types of user interface indicators.

An exemplary operation of the switch control processor 330 in accordance with the present invention is illustrated in FIG. 3. The driving mode of the operator of the vehicle is translated into a form as the input to the switch control processor. If the driving state is acceleration/torque 310, this state is sensed by the switch control processor, and the switch control processor, in turn, configures battery switching module 394 for setting batteries in parallel to deliver more current to the power grid and, ultimately, to the motor coupled to the grid. In such parallel connection mode switches 340-1 to 340-3 are closed (“on’) and switches 340-4 to 340-5 are open (“off”). The reverse charging between the batteries is blocked by power diodes 390-1 to 390-2, although other forms of regulation and switching might be employ ed. Alternatively, batteries might be connected in series to offer increased voltage by closing the switches 340-4 to 340-5 while opening switches 340-1 positive path, 340-2 negative path, and to 340-3 negative path in the battery switching module. In either above-mentioned condition, both batteries drain or otherwise deplete energy if operator of the vehicle has reached desired target speed and desires to maintain speed, a relatively lower energy consumption is required and only one battery may be switched on to the grid by setting 340-1 switch to on and turning off all other switches 340-2 to 340-5 off. The battery utilization is performed in a systematic way by grouping corresponding sets of batteries into group 395-1, group 395-2, and 395-3. One skilled in the art might use more or less numbers of groups shown in this exemplary grouping.

Each group is further comprised of a plurality of batteries. In this exemplary macro grouping group 395-1 comprises micro batteries 396-1 and 396-2, macro group 395-2 comprises micro batteries 396-3 and 396-4, and macro group 395-3 comprises micro batteries 396-5 and 396-6. While each battery in micro batterys 396-1, 2, 3, 4, 5, 6 may, in turn, comprise additional smaller micro-micro battery modules connected in series or parallel combination as appropriate. During battery utilization period, group 395-1 is utilized before group 395-2 is brought in to operation unless there is a need for enhanced energy output when one or more or all of the battery units will be utilized in suitable series parallel combination. Similar operation occurs for smaller battery modules to the smallest battery element in the smallest battery module grouping.

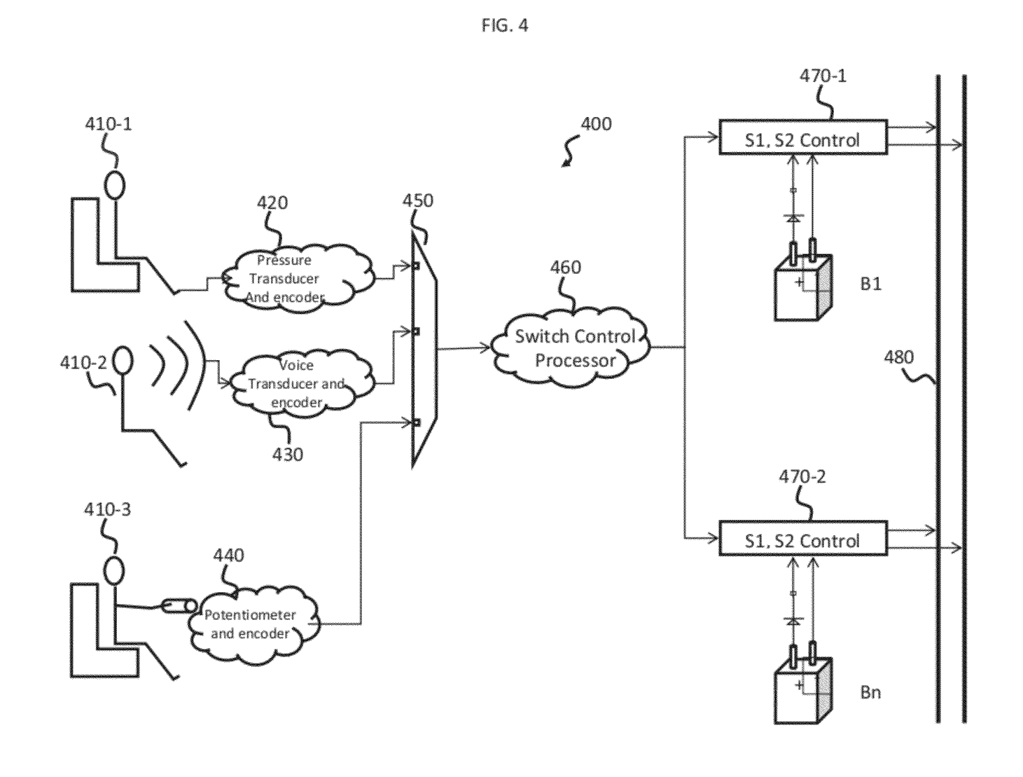

FIG. 4 demonstrates an exemplary mechanism to convey driving mode information, without limiting the scope of the current invention to cited examples, to the switch control processor 460. In this exemplary embodiment, the operator of the vehicle 410-1 presses the accelerator or other form of pressure sensitive medium, the pressure information is translated to electrical information using pressure transducer 420 in an appropriately encoded manner compatible with the switch control processor decoder. Alternately the operator of the vehicle 410-2 may speak the operation mode (such as acceleration, hold speed constant, deceleration or similar), the voice of the operator is translated to electrical information by the voice transducer and accompanying encoder compatible with switch control processor 460. Alternately the operator of the vehicle 410-3 may control a sliding bar, for example, to control a potentiometer and the output of the potentiometer is appropriately encoded 440 compatible with the switch control processor. A vehicle may have one or more such interfaces. Switch control processor 460 translates operator intent input in to switch control, as explained in FIG. 3, by connecting one or more batteries in series or parallel configuration connected to the grid powering the motor.

During the course of driving, user intent is translated into vehicle operating states based on torque, acceleration, or steady state speed maintenance. Each of these driving intents requires either relatively large short term high current supply to the motor power grid, or steady constant current supply. FIG. 5 shows an exemplary connection diagram of the available batteries. The battery configuration connection is controlled by the switch control processor 505, while the switch control processor translates current demand or voltage demand request 506 by the operator of the vehicle. Battery compartment 210 comprises macro batteries 395-1 of a type A, shown as Type A high current source 510 in FIG. 5, which, for this exemplary illustration, is suitable for delivery of high current supply. If vehicle operation state requires high current delivery as requested by request input 506, switch control processor 505 adds battery 510-2 in parallel with currently active battery 510-3 in motor power grid 550 by activating switch 530-2 with existing switch 530-3.

If further or more current is demanded by the operating state of the vehicle, more batteries are added (such as battery 510-1) to motor power grid 550 by activating switch 530-1 in this exemplary representation, without limiting the number of batteries beyond the exemplary system. The parallel combination of batteries is actively coupled to motor power grid 550 with switch 530-4. If the driving state requires immediate disengagement of power, such as in brake engagement, switch control processor 505 de-activates switch 530-4 and along with optionally de-activating one or more switches 530-1 to 530-3 isolating one from another. In another embodiment of this invention switch 530-3 and switch 530-4 might be implemented with a single switch. The battery compartment 210 consists of macro batteries 395-2 of a type B, 520 battery series in FIG. 500, in this exemplary representation that is suitable for delivery of constant current supply.

If the vehicle operating state requiring constant current supply is supported with batteries with type B characteristics, shown as Type B high voltage source 520 in this exemplary representation, operation is as follows. Battery series 520 is connected to motor power grid 550 by switch 540-4. Initially battery 520-3 is connected to the motor power grid 550 by activating switch S1 540-3. In another embodiment of the present invention switch 540-4 and 540-3 are implemented as the same switch. If the driving state requires more power as requested by switch control processor 505 inputs 506, switch control processor 505 adds an additional battery 520-2 in series with battery 520-3 by de-activating switch 3) and activating switches S2.1, S2.2, and S2.3, if even more power is required by the operating state of the vehicle with constant current source, battery 520-1 is activated in the motor power grid by connecting it in series with batteries 520-3 and 520-2 by de-activating switch S2.2 and retaining originally deactivated switch S1, but activating switch S3.1, S3.2, and S3.3. Additional batteries might be added in series for even more power delivery in this exemplary battery configuration system without limiting the scope of the invention.

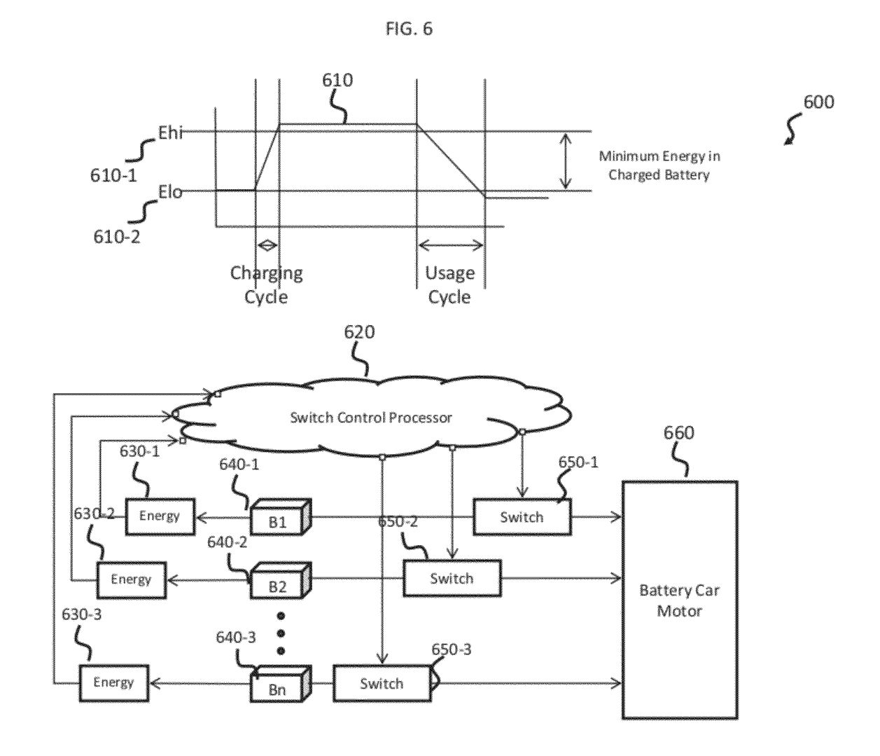

FIG. 6 illustrates an exemplary mechanism to inform switch control processor 620 the charge status of each battery controlled by a switch control processor. The connection of batteries B1 to Bn indicated by 640-1 to 640-3 to battery car motor power grid 550 illustrated in FIG. 5 are controlled by a switch control processor in a sequential way. An exemplary method now described employs battery B1, which in turn includes a plurality of smaller batteries as illustrated in FIG. 3 until its energy sensor detects energy level drops below level Elo 610-2 indicating utilization (depletion) of the battery. The energy sensor is an integral part of each battery. Energy sensor 630-1 is associated with battery 640-1 and presents a low battery status to switch control processor 620 when detected. Switch control processor 620, in turn, takes battery 640-1 off line until it is recharges while mounted in the vehicle or when replaced by a recharged battery facility with a charged battery. When the enemy level of battery B1, 640-1 is above Ehi 610-1 the energy sensor 630-1 indicates the charged status of the battery to the switch control processor, and is then switch control processor 620 brings battery B1, 640-1 on line. When the battery B1 is offline, switch control processor 620 deactivates switch 650-1, and disconnects battery B1, 640-1 from the power grid supplying energy to the motor. When energy sensor 630-1 indicates battery refreshment by charging or by swapping with a new battery, switch 650-1 is then controlled as previously described by switch control processor 620 to serve the motor when a need for electrical energy is required. The battery B2 to Bn, 640-2 to 640-3 has similar energy sensors 630-2 and 630-3 informing switch control processor the battery energy status. The switch control processor in turn controls switches 650-2 to 650-3 for supporting the motor power grid.

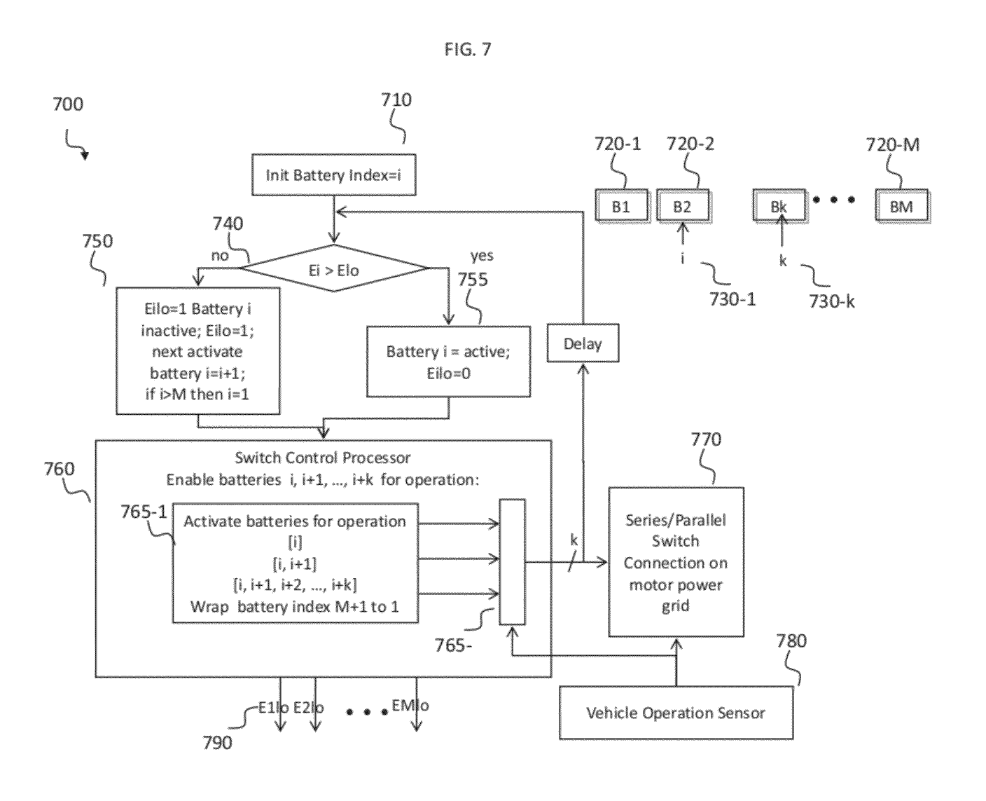

Referring to FIG. 7, switch control processor 620 manages macro battery usage in a block-sequential manner in one embodiment of the invention. In block sequential usage operation, the available batteries are indexed by an index 730. At a given time, battery 720-2, indexed by i 730-1, is actively switched to the motor power grid as demanded by the vehicle operating mode. Battery 720-2, indexed by 730-1, is referred to herein as the ith indexed battery is defined as a current or active battery. If the vehicle operating mode demands more power, additional batteries 720-X indexed by i+1, . . . , i+k 730-2, . . . , 730-k, can be connected to the motor power grid using the series parallel connection configuration as described in reference to FIG. 5. As the vehicle operating triode demands less power, first battery indexed by 730-k is taken off, and then battery indexed by 730-2 is taken off the grid with lower battery demand. The default battery 720-2 indexed by i=730-1 supports power demand by the vehicle operating mode. Again, additional batteries with higher index might be brought in as power demand increases again. The flow chart in FIG. 7, in one embodiment of the current invention, shows at initial stall-up the default battery is indexed by i. In step 740, the current energy status of the battety is tested (Ei>Elo). If the battery energy indexed by i is above Elo 610-2, then, in step 755 the battery is designated active by setting the low battery status indicator to 0 and by setting the status flag Eilo=0. If the battery energy is below Elo 610-2, then, in step 750 the battery indexed by i is designated inactive by setting the low battery status indicator to I by setting Eilo=1 and the current battery index is updated to the next value. If the index is greater than the available batteries, such as M, the index is set to 1 for modulo indexing of the available batteries. After battery energy status update, switch control processor 760's battery allocator assign batteries Ei as current default operating battery and also assigns additional batteries Ei+1, Ei+2, . . . , Ei+K 765-1 on demand ready.

In normal operation battery, Ei supplies electrical energy to motor power grid 550 and when the vehicle operation sensor 780 demands additional energy the assigned on demand ready batteries are enabled 765-2 on the power grid through series or parallel combination of the batteries 770 based on power demand from vehicle operation sensor 780 using the series parallel connection scheme described in FIG. 5. In additional to enabled battery series/parallel connection to motor power grid 550, the battery energy status indicator fanout block 790 indicates the battery-by-battery energy state. The battery-by-battery energy state indication is presented in a plurality of state values. In analog representation, energy state indication may be via control a light emitting diode (LED) intensity to convey the battery energy state. In an alternate embodiment attic present invention the battery-by-battery energy state can be digitized using an analog to digital converter (A/D), and the digital representation used to present the battery status via a status bus to digital readout. Battery status indicator fanout block 790 is employed as a user interface indicating battery usage status, battery station indicating used batteries requiring replacement or charging, and the switch control processor to bring the battery on the grid or to take the battery off the grid.

In block sequential usage mode, a newly charged battery or an in place charging of battery starts with earliest battery having energy level falling below Elo 290-3. The charged battery swap or in place charging continues sequentially to the most recent battery, adjacent to the current or active battery whose energy level fallen below Elo 290-3. A battery is referred to be decommissioned when its energy level falls below the lower threshold Elo 290-3. A battery with energy level higher than Ehi 290-1 when replaced into the slot of a decommissioned battery through in place charging or swapping with a charged battery is referred to as battery commissioning. When all decommissioned batteries are commissioned, the sequential commissioning in a block sequential manner from the earliest decommissioned battery to last decommissioned is not necessarily performed and commissioning in any order is performed between the last decommissioned battery to the latest decommissioned battery prior to the current also known as the active battery.

FIG. 8 shows a process for indicating battery usage status i) to the operator of the vehicle or ii) to the battery station indicating batteries requiring charging or replacement service. Each macro battery unit 395 is a module that might be recharged or replaced with a charged battery as one unit, Micro batteries 396 are not necessarily replaced as a unit, hut in preferred embodiments micro batteries 396 are formed as a macro battery unit treated as a single, swappable Of replaceable unit. Each replaceable unit has an associated energy sensor 730. In an alternate embodiment of the present invention the energy sensor may be a shared device used by a plurality of batteries in a time-multiplexed manner to measure the stored energy content of the batteries at their respective time allocated energy measurement time. The status of the battery energy is displayed in the vehicle operator driving console 850 to provide an indication of the state of the battery energy using a plurality of display mechanism.

In one embodiment, the battery-by-battery energy state might be displayed by the intensity of an LED 860 per battery or by color coding the energy state in to colors such as red being empty, yellow being near empty and green being full as an exemplary color coding (but the present invention is not restricted to such color designations). After a full battery recharge, the last active battery indexed by i, 730-1, will be displayed as 1^{st} battery in the vehicle battery status display console of various forms, 860, 880, 890. As the batteries starting at index i, is decommissioned, their status in LED or bar, or analog indicator is displayed from left to right, top to bottom, or vise versa in a sequential manner. The physical absolute battery location numbering B1 to BM, 720-1 to 720-M, is displayed with the dynamic battery numbering where the current battery index, dynamic index, starts with the first relative location after a full battery commissioning. In an alternate representation, the battery energy state may be presented by energy state bar 880. The battery-by-battery bar indicates the energy state of individual battery. Once an individual battery is fully charged, the bar is full and as the battery starts to deplete the energy the bar starts to drop by suitable color coding. Alternatively, the battery state may be displayed using analog indicator 890 by displaying the number of depleted batteries in lop and the last unused battery number in the bottom. Such an exemplary battery status representation is without restriction of the used up battery in the top and the last unused battery in the bottom, and allows for any convenient positioning of the batteries in the analog display panel.

In the display panel the battery number such as B1, B2, . . . , Bn are displayed by the order the battery usage status is displayed. To indicate the battery status to the battery service station equipment, the energy status of each battery module is also displayed on the body of the battery itself using LED 820 light intensity or color coding as done in battery operator console described earlier. To equip battery station with digital reader the energy state of each battery is further quantized with an analog to digital converter, not shown in figure that is readily known by one skilled in the art, of a defined bit width and making the battery energy status quantized bus available to battery station battery status reader digital bus using outlet 810. As explained earlier in FIG. 6 the battery sensor output is also supplier to the switch control processor 620 such that it can use the batteries for series/parallel connection configuration as long as the batteries have stored electrical energy above a pre-defined energy threshold 610-2.

Alternatively, a battery car in accordance with one or more embodiments of the present invention might incorporate transceiver for a wireless interface, such as WiFi, WiMAX, 3G or 4g-LTE, satellite-based, or other data communication system. In such case, the switch control processor might then communicate battery status and type to the battery car station device enabling battery charging, swapping or replacement. If the battery car is adjacent to the battery car station charging/swapping device, the positions and types of batteries for replacement can be indicated by the switch control processor to the charging/swapping device. Further, if a battery car is in route and geographically located among several battery car stations, the switch control processor of the battery car might i) call ahead to a given station to prepare the station for the swapping operation for the correct battery number and type and/or ii) identify a station having sufficient number of the correct battery types and communicate this to the vehicle operator to select a station. Such activity might advantageously incorporate GPS information of an on-board navigation system of the battery car to locate such stations with reference to the battery car's present location.

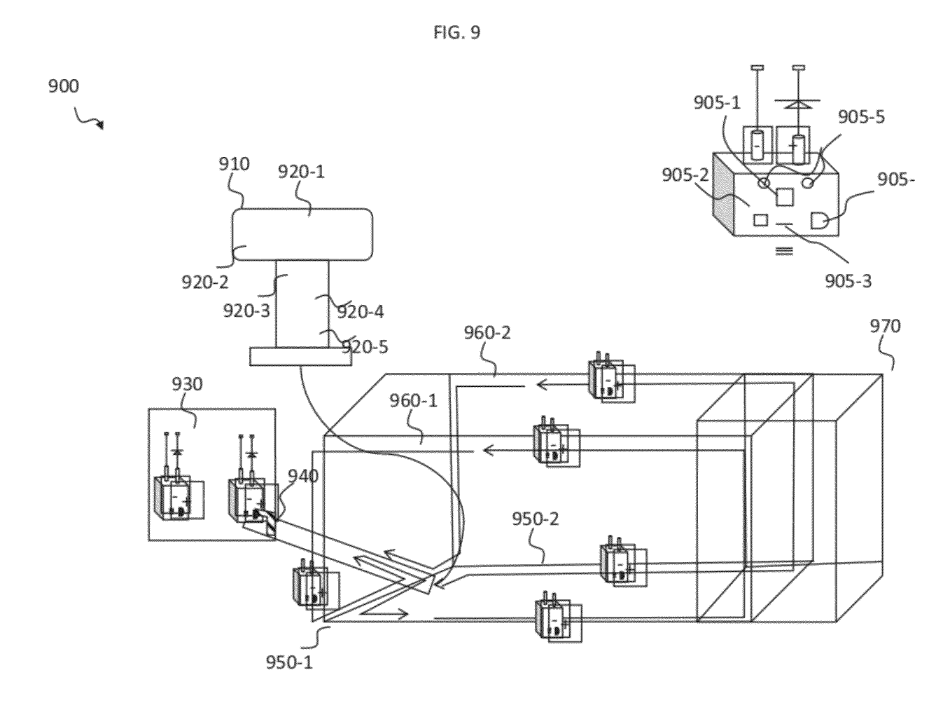

FIG. 9 shows exemplary operation of a battery service station. A battery car requiring battery charging service or battery swapping with recharged battery service docks itself in the battery station. According to the present invention, the battery used by the battery car and serviced by battery station has a plurality of battery status and battery attribute indicators. The battery 395 indicates the battery type 905-1, such as type A, type B and such, using bar code, color code, digital code or other suitable status indication ports. Battery 395 might indicate the charge status by light intensity or light color of an LED 905-4. Battery 395 might indicate the charge status by a digitally coded bus 905-3 wherein the bus is an output of a memory device and the memory device is updated by the battery sensor output, in specific embodiment of the present invention one or more status indicator may be realized that can be updated by the battery sensor on to the body of the battery as an integral part of the battery and sensed by the battery car and battery service station sensors. The battery 395 has a means to count and update number of times the batteries are charged in a charge cycle counter 905-2 as an integral part of the battery attached to the body of the battery. The battery has convenient charging port inlet for positive terminal and negative terminal 905-5 for convenience of in place charging of the batteries or sensing the current state of the battery charge. In describing the battery status, battery charge, battery energy, simply battery status or similar term are used interchangeably herein to refer to or to indicate the stored energy 290 of the battery.

After the battery car requiring battery service docks in the battery station preferably aligning the battery status indicators with battery service station battery sensors, battery station service panel 910 is employed to obtain service. The automatic or manual service mode selection 920-3 determines what type of service is desired. If manual service is required, the batteries that indicate low or empty status in battery car battery status console 850 are entered in battery selector 920-2 and activates service request by selecting battery service activation 920-4 selector. In place charging is selected by selector switch 920-5 and in place service supports either automatic selection of battery charging service or manual selection of battery charging service.

If automatic service is required, automatic battery service selection 920-1 is selected. In either automatic or manual battery service mode battery station lever 250 attaches to one or more batteries in battery compartment 150-2, (shown as battery compartment 930 in FIG. 9). In automatic service mode, a set of compatible sensor array 940 attached to lever 250 detects the battery energy level. If the energy level is below 290-3, the battery is then unlocked from battery compartment 930. The sensor also senses the battery type by sensing 905-1. The detached battery is then routed to the charging queue of same type of battery as detected by the sensor sensing 905-1. If the manual service is requested, the lever goes straight to the selected battery, detaches it, and routes it to the same type of battery either detected automatically by sensing 905-1 or selected by the service requester.

The manual or automatic mode of battery removal continues until all batteries requiring service are removed and routed to appropriate queue. The battery type of the battery needing replacement is sensed by the sensor at the sense port 905-1. In this exemplary embodiment, if the battery type is detected as type A, the battery is routed to the battery type A charging queue 950-1. If the detected battery type is B, the battery is routed to the battery type B charging queue 950-2. In battery charging chamber 970, the batteries are charged. After batteries are charged above energy threshold Ehi 610-1, the type A batteries are sent to type A charged battery queue 960-1 and type B batteries are sent to type B charged battery queue 960-2. The battery charge counter of the said battery is incremented by a preset value. For most application the preset value is 1, without restricting other possible values. Type A batteries removed from the car receive replacement charged batteries from type A charged battery queue 960-1. Type B batteries removed from the car receive replacement charged batteries from type B charged battery queue 960-2. The invention is not limited to charging queue and discharging queue of two type of batteries, type A and type B, but any number of batteries are within the scope of the present invention.

In addition, the lever assembly might be equipped with a plurality of in place charging electrodes for charging the batteries in place in the vehicle using port 905-5 (positive and negative inlets). The in place charging is selected with selector 920-5 and in place charging supports both manual and automatic service request mode.

Having described the configuration and operation of a battery car with multiple battery types selectively coupled to a grid via switches controlled by a switch control processor, the teachings herein are now described by extending operation to two or more power grids. Since the power requirements to drive a vehicle are different from those required to power some devices such as headlights and a radio, depleted batteries with low charge but not completely discharged may be switched from the grid driving the motor to another grid for low-power devices. Such switching might also incorporate switching voltage regulation between grids since the voltages required to drive the motor might be different from the voltages required to drive the rest of the battery car electrical system. For such configuration, the battery sensing operation described herein might be extended to detecting multiple thresholds (Ehi, Enid and Elo, for example), where batteries are also then selectively coupled to different grids based on the detected threshold.

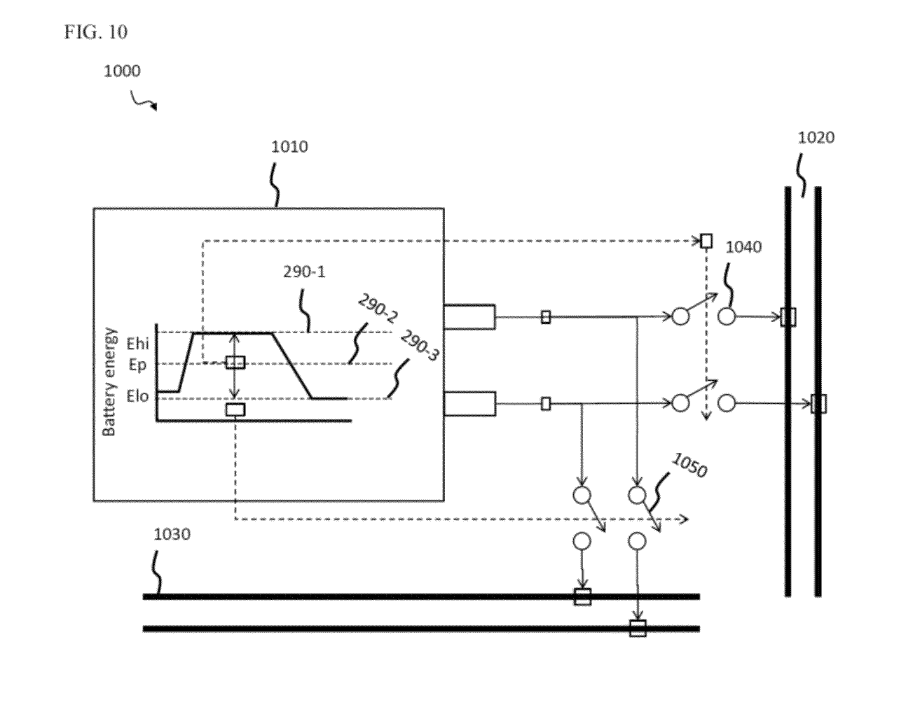

FIG. 10 demonstrates an exemplary mechanism where a battery 1010 is connected to the motor power grid 1020 when the battery energy level is above minimum energy threshold 290-3 by connecting the battery to the engine power grid using switch 1040. When the battery energy level falls below energy threshold 290-3, it does not have enough drive power to power the motor but has enough power to support the auxiliary devices in car. The battery connection is switched to auxiliary power grid 1030 using the switch 1050 when the battery energy level falls below the energy threshold 290-3.

Similarly, the switch control processor might switch between grids employed for powering the motor and electrical system, and grids employed for recharging the batteries while the battery car moves down the road. Obviously, a battery car can recharge by collecting energy generated while coasting or moving down-hill, as well as by alternative sources, such as solar panels, mounted to the battery car. In such configuration, certain battery types might be advantageously recharged via different means, leading to switching out discharged batteries from powering/driving grids and coupling them to corresponding recharging grids.

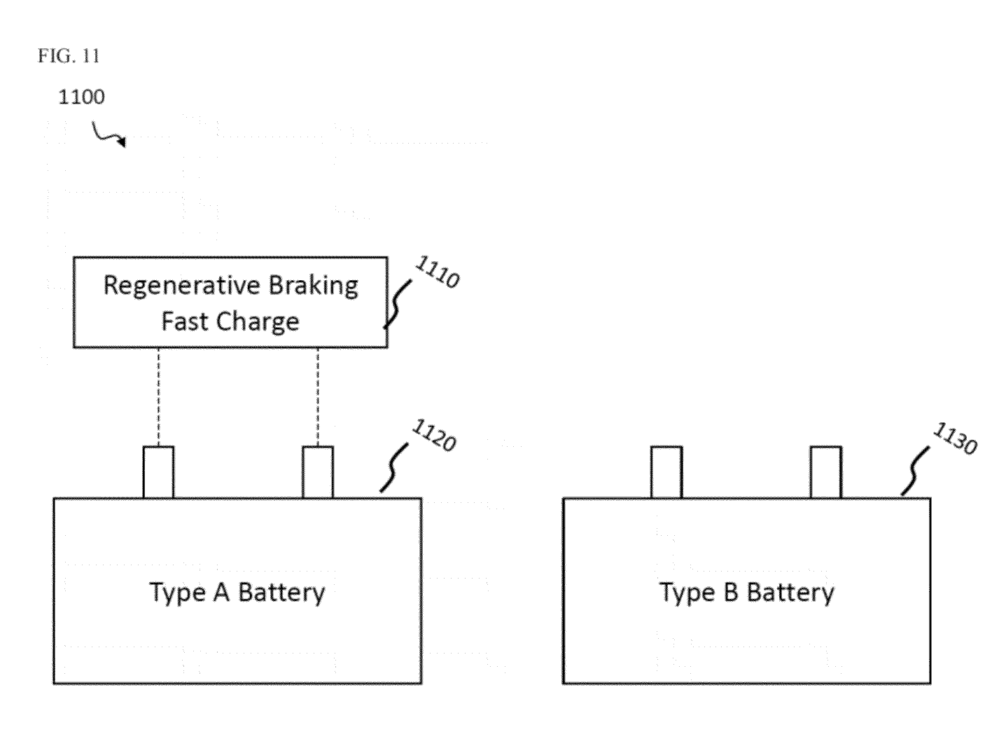

FIG. 11 demonstrates an exemplary mechanism where the fast charging battery A 1120 is recharged by the regenerative breaking mechanism 1110 which uses the kinetic energy of the car fly wheel or similar entity with kinetic energy reserve when the car's brakes are pressed. In contrast, slow charging battery 1130 is charged isolated from the recharging system and charged in the battery station facility.

As the present invention relies on batteries of varying types suitable for electric car use, the following describes some available technologies for implanting these batteries. Rechargeable batteries include Lead acid batteries, Nickel-Metal-Hydride (NiMH) batteries, Nickel-Cadmium (NiCad) and Lithium-Ion batteries. Lead acid batteries typically are short range batteries per charge, NiMH and NiCad batteries typically are mid range batteries per charge, and Lithium-Ion batteries typically are long range batteries per charge. Batteries might be evaluated by four factors: energy/weight ratio, energy volume ratio, power to weight ratio, and cost in watt hours per dollar. Two other factors are employed for classification: self-discharge rate (time for charge to diminish) and number of times the battery can be deep-discharged and recharged.

Further, as mentioned above, the battery types are classified into slow charging and fast/quick charging. NiCad and lead acid are typically the most robust for slow charging (overnight charge or 14-16 hours charging at 0.1C rate), while quick/fast charging is often a factor of battery design (quick charge is 3-6 hours charging at 0.3C rate; and fast charging is less than 1 hour charging at 1.0C rate). The following table 1 summarizes such use:

TABLE 1

| | Charge Termination Methods | | | |
|---|---|---|---|---|
| | SLA | Nicad | NiMH | Li-Ion |
| Slow Charge | Trickle OK | Tolerates | Timer | Voltage Limit |
| | | Trickle | | |
| Fast Charge 1 | Imin | NDV | dT/dt | Imin at Voltage |
| | | | | Limit |
| Fast Charge 2 | Delta TCO | dT/dt | dV/dt = 0 | |
| Back up | Timer | TCO | TCO | TCO |
| Termination 1 | | | | |
| Back up | DeltaTCO | Timer | Timer | Timer |
| Termination 2 | | | | |

where TCO = Temperature Cut Off;
Delta TCO = Temperature rise above ambient and
Imin = Minimum current.

For purposes of this description and unless explicitly stated otherwise, each numerical value and range should be interpreted as being approximate as if the word “about” or “approximately” preceded the value of the value or range. Further, signals and corresponding nodes, ports, inputs, or outputs may be referred to by the same name and are interchangeable.

Additionally, reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the terms “implementation” and “example,”

Also the purposes of this description, the terms “couple,” “coupling,” “coupled,” “connect,” “connecting,” or “connected,” refer to any manner known in the art or later developed in which a signal is allowed to be transferred between two or more elements and the interposition of one or more additional elements is contemplated, although not required. Conversely, the terms “directly coupled,” “directly connected,” etc., imply the absence of such additional elements.

It is understood that various changes in the details, materials, and arrangements of the parts which have been described and illustrated in order to explain the nature of this invention may be made by those skilled in the art without departing from the scope of the invention as expressed in the following claims.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

We claim:

1. Apparatus for powering a transporter having an electric motor powering a drive-train, comprising:
a battery chamber configured to retain a plurality of battery modules, the plurality of battery modules including at least two battery types and wherein each battery module comprises a power level sensor and indicator;
at least one power grid, one power grid coupled to and configured to provide power to the electric motor;
a switch array coupled between the motor power grid and the plurality of battery modules; and
a switch control processor coupled to the switch array and to each of the plurality of battery modules, the switch control processor configured to receive i) a corresponding energy level from each battery power level sensor and indicator, ii) a battery type identity, and iii) operational mode corresponding to the transporter,
wherein the switch control processor selectively enables and disables switches of the switch array so as to selectively activate one or more batteries in a unidirectional, isolated connection manner so as to power the motor via the motor power grid; and
wherein the switch control processor selectively activates the one or more battery modules based on the corresponding energy level from each battery power level sensor and indicator and the battery type identity for each battery so as to concurrently provide the power for the operational mode of the transporter while reducing a number of battery modules providing the power.

2. The apparatus as recited in claim 1, wherein:
the switch control processor selectively decommissions a battery module when the battery module energy threshold falls below a first energy level; and
the switch control processor selectively commissions a battery module when the battery module energy threshold is above a second energy level, wherein, when selectively activating the one or more battery modules, the switch control processor selects from one or more commissioned battery modules.

3. The apparatus as recited in claim 2, wherein:
a set of battery modules of the plurality of battery modules in said battery chamber is selectively replaceable; and
each corresponding power level sensor and indicator is configured to indicate a decommissioned battery in said battery chamber,
wherein a battery service station, based on an indication of a decommissioned battery, either i) replaces the decommissioned battery with a charged battery above the second energy level or ii) charges the decommissioned battery in the battery chamber.

4. The apparatus as recited in claim 3, wherein, when the battery service station either i) replaces the decommissioned battery with a charged battery above the second energy level or ii) charges the decommissioned battery in the battery chamber, the switch control processor selectively commissions each decommissioned battery module when the battery module energy threshold is above the second energy level.

5. The apparatus of claim 2, wherein:
when the switch control processor selectively decommissions the battery module, the switch control processor is further configured to selectively designate the battery module next in usage queue as active, and
when the switch control processor selectively commissions the battery module, the switch control processor is further configured to selectively place the battery module at an end of the battery usage queue.

6. The apparatus of claim 1, wherein when the switch control processor selectively enables and disables switches of the switch array so as to selectively activate one or more batteries in a unidirectional, isolated connection manner so as to power the motor via the one power grid, the switch control processor is configured to selectively add or disconnect additional battery modules in accordance with a battery usage queue a demand for the power fluctuates based on the operational mode corresponding to the transporter.

7. The apparatus of claim 6, wherein the switch control processor sets each active battery of the usage queue in parallel connection as current demand increases.

8. The apparatus of claim 6, wherein the switch control processor sets each active battery of the usage queue in series connection as voltage demand increases.

9. The apparatus of claim 1, wherein a battery energy status is indicated in a driver console with a plurality of color of first type if said battery energy is above a first threshold, a color of last type if said battery energy is below last threshold and a plurality of other colors corresponding to a plurality of other thresholds of said battery when below their respective thresholds.

10. The apparatus of claim 1, wherein a battery module of a first type is suitable for delivering short term high current and a battery module of a second type is suitable for delivering long term steady adjustable current.

11. The apparatus of claim 1, wherein each battery module of a given type is composed of one or more micro batteries connected to each other in series or in parallel form.

12. The apparatus of claim 1, wherein the switch control processor indicates to an operator a current requirement for the operational mode corresponding to the transporter.

13. The apparatus of claim 1, further comprising an electronic device grid, wherein:
the switch control processor selectively enables and disables switches of the switch array so as to selectively activate one or more batteries in a unidirectional, isolated connection manner so as to power one or more electronic devices via the electronic device grid; and
the switch control processor selectively activates the one or more battery modules based on the corresponding energy level from each battery power level sensor and indicator and the battery type identity for each battery so as to concurrently provide the power for the one or more electronic devices via the electronic device grid while reducing a number of battery modules providing the power.

14. The apparatus of claim 1, further comprising a recharging grid, wherein:
the switch control processor is further configured to selectively enable and disable switches of the switch array so as to selectively couple one or more battery modules to a recharging device via the recharging grid; and
the switch control processor is configured to selectively couple the one or more battery modules to the corresponding recharging device based on the corresponding energy level from each battery power level sensor and indicator and the battery type identity for each battery.

15. The apparatus of claim 1, further comprising a wireless communication module, wherein:
the switch control processor is further configured to select one or more battery modules to decommission and to indicate, via the wireless communication module to a battery service station, each decommissioned battery module with the corresponding battery type for replacement or recharging of each decommissioned battery module by the battery service station.

16. The apparatus of claim 15, further comprising a geographic location module, wherein:
the switch control processor is further configured to select a battery service station from a plurality of battery service stations based on a geographic location of the transporter provided by the geographic location module.

17. The apparatus of claim 15, further comprising a geographic location module, wherein:
the switch control processor is further configured to select the battery service station from the plurality of battery service stations based on an availability of each battery module type located at each of the plurality of battery service stations.

18. A battery service station comprising:
a scanning device configured to identify a set of battery modules of the plurality of battery modules and types in said battery chamber for replacement or for charging, based on each corresponding power level sensor and indicator of the plurality of battery modules indicating a decommissioned battery in said battery chamber; and
a crane configured to i) unlock and remove a decommissioned battery from said battery chamber; ii) insert and lock a new battery in said battery chamber; and ii) charge a battery module in said battery chamber;
wherein the scanning device identifies each given type of battery module, and the battery service station, based on an indication of a decommissioned battery, either i) replaces the decommissioned battery with a charged battery above the second energy level of the given type or ii) charges the decommissioned battery in the battery chamber.

19. The battery service station of claim 17, further comprising a conveyer system, the conveyer system configured to provide new battery modules of a given type to the crane; and the conveyer system configured to remove the decommissioned batteries from the crane and provide the decommissioned batteries to a remote charging device.

20. A method of powering a transporter having an electric motor powering a drive-train, comprising:
Retaining, with a battery chamber, a plurality of battery modules, the plurality of battery modules including at least two battery types and wherein each battery module comprises a power level sensor and indicator;
providing power to the electric motor through at least one power grid coupled to the electric motor;
providing a switch array coupled between the motor power grid and the plurality of battery modules; and
receiving, by a switch control processor, i) a corresponding energy level from each battery power level sensor and indicator, ii) a battery type identity, and iii) operational mode corresponding to the transporter, the switch control processor coupled to the switch array and to each of the plurality of battery modules,
selectively enabling and disabling, by the switch control processor, switches of the switch array so as to selectively activate one or more batteries in a unidirectional, isolated connection manner so as to power the motor via the motor power grid; and
selectively activating, by the switch control processor, the one or more battery modules based on the corresponding energy level from each battery power level sensor and indicator and the battery type identity for each battery so as to concurrently provide the power for the operational mode of the transporter while reducing a number of battery modules providing the power.

21. The method as recited in claim 20, comprising:
selectively decommissioning, by the switch control (processor, a battery module when the battery module energy threshold falls below a first energy level; and
selectively commissioning, by the switch control processor, a battery module when the battery module energy threshold is above a second energy level, wherein, when selectively activating the one or more battery modules, the switch control processor selects from one or more commissioned battery modules.
